(19) United States
(12) Patent Application Publication
(10) Pub. No.: US 2016/0050663 A1
(43) Pub. Date: Feb. 18, 2016

(54) SYSTEM AND METHOD FOR INCREASING DATA RATE OF COMMERCIAL CELLULAR COMMUNICATION SYSTEMS WITH SCATTERED SPECTRUM

(71) Applicant: Aviacomm Inc., Sunnyvale, CA (US)

(72) Inventors: Hans Wang, Mountain View, CA (US); Tao Li, Campbell, CA (US); Binglei Zhang, San Jose, CA (US); Shih Hsiung Mo, San Jose, CA (US)

(73) Assignee: AVIACOMM INC., Sunnyvale, CA (US)

(21) Appl. No.: 14/791,381

(22) Filed: Jul. 3, 2015

Related U.S. Application Data
(60) Provisional application No. 62/037,995, filed on Aug. 15, 2014.

(51) Int. Cl. H04W 72/04; H04W 24/08; H04W 72/12; H04L 12/911; H04W 16/14; H04W 72/14

(52) U.S. Cl. CPC H04W 72/0453; H04W 16/14; H04W 72/14; H04W 72/1252; H04L 47/827; H04W 24/08

(57) ABSTRACT

One embodiment of the present invention provides a system for implementing Long-Term Evolution (LTE) scheduling in a wireless communication system with scattered spectrum. During operation, the system determines bandwidth resources that are available in the wireless communication system. The available bandwidth resources comprise a plurality of scattered spectrum pieces. The system identifies a spectrum piece that has a bandwidth that is equal to or larger than a predetermined threshold, defines a logical channel that is centered at the identified spectrum piece, and performs LTE scheduling based on the defined logical channel, wherein the LTE scheduling involves provisioning a user or a service using spectrum pieces encompassed in the defined logical channel.

### RELATED APPLICATION

This application claims the benefit of U.S. Provisional Application No. 62/037,995, Attorney Docket Number AVC14-1006PSP, entitled “Using Scattered Spectrum on Commercial Cellular Communication System,” by inventors Hans Wang, Tao Li, Binglei Zhang, and Shih Hsiung Mo, filed 15 Aug. 2014.

### BACKGROUND

1. Field

The present disclosure relates generally to a commercial wireless communication system that supports scattered spectrum pieces. More specifically, the present disclosure relates to implementing Long-Term Evolution (LTE) in such a system.

2. Related Art

In the past decade, LTE (also known as the fourth generation (4G) LTE) has been replacing the third generation (3G) technology as the current mobile telecommunications technology. It is developed from the GSM (Global System for Mobile Communications)/UMTS (Universal Mobile Telecommunications System) technology. By using new DSP (digital signal processing) techniques and modulations, LTE can increase the capacity and speed of wireless data networks.

The increased capacity and speed provided by the LTE technology have prompted the desire to extend LTE usage from a public cellular network to other cellular communication systems, including commercial or military cellular communication systems. However, the allocation of spectrum in certain commercial cellular communication systems is very different from public cellular communication systems, making direct implementation of LTE in those systems a challenge.

### SUMMARY

One embodiment of the present invention provides a system for implementing Long-Term Evolution (LTE) scheduling in a wireless communication system with scattered spectrum. During operation, the system determines bandwidth resources that are available in the wireless communication system. The available bandwidth resources comprise a plurality of scattered spectrum pieces. The system identifies a spectrum piece that has a bandwidth that is equal to or larger than a predetermined threshold, defines a logical channel that is centered at the identified spectrum piece, and performs LTE scheduling based on the defined logical channel, wherein the LTE scheduling involves provisioning a user or a service using spectrum pieces encompassed in the defined logical channel.

In a variation on this embodiment, the system monitors traffic need, and in response to determining that spectrum pieces encompassed by the logical channel do not meet the traffic need, aggregates multiple logical channels to obtain an aggregated channel. The system then provisions the user or the service using spectrum pieces encompassed in the aggregated channel.

In a further variation, aggregating the multiple logical channels involves performing LTE carrier aggregation.

In a further variation, the system disaggregates previously aggregated multiple logical channels in response to determining that spectrum pieces encompassed by a single logical channel meet traffic need.

In a variation on this embodiment, the defined logical channel has a bandwidth that is in compliance with an LTE standard.

In a variation on this embodiment, the wireless communication system includes an aviation cellular communication system, and the scattered spectrum pieces are located within a frequency band between 200 MHz and 400 MHz.

In a variation on this embodiment, the scattered spectrum pieces include a number of 500 kHz wide spectrum pieces and a number of 1.2 MHz wide spectrum pieces, and the identified spectrum piece is 1.2 MHz wide.

### BRIEF DESCRIPTION OF THE FIGURES

FIG. 1 presents a diagram illustrating an exemplary aviation cellular communication system.

FIG. 2 presents a diagram illustrating the distribution of available spectrum within an aviation cellular communication system.

FIG. 3 presents a diagram illustrating an exemplary scenario where logical channels are defined, in accordance with an embodiment of the present invention.

FIG. 4 presents a diagram illustrating an update to the logical channels in response to an update to the available spectrum, in accordance with an embodiment of the present invention.

FIG. 5 presents a diagram illustrating defining logical channels around an anchor point, in accordance with an embodiment of the present invention.

FIG. 6 presents a diagram illustrating the exemplary architecture of a scheduler, in accordance with an embodiment of the present invention.

FIG. 7 presents a flowchart illustrating an exemplary bandwidth provisioning process, in accordance with an embodiment of the present invention.

FIG. 8 illustrates an exemplary system for implementing LTE in systems with scattered spectrum, in accordance with an embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a method and a system for implementing Long Term Evolution (LTE) technology in a commercial cellular communication system that supports smaller scattered spectrum pieces. During operation, based on the spectrum pieces that are currently available, the system defines logical channels whose bandwidths are in compliance with the LTE standard. More specifically, while defining the logical channels, the system identifies an available spectrum piece that is wide enough to enable LTE synchronization, and uses the identified spectrum piece as an anchor point to define logical channels. The logical channels are defined to center at the anchor point. The system treats other smaller spectrum pieces as individual resource blocks (RBs) that can be allocated to users or services. Moreover, the system performs on-demand channel aggregation if available spectrum in a single logical channel does not meet users' demand for bandwidth.

### Aviation Cellular Communication System

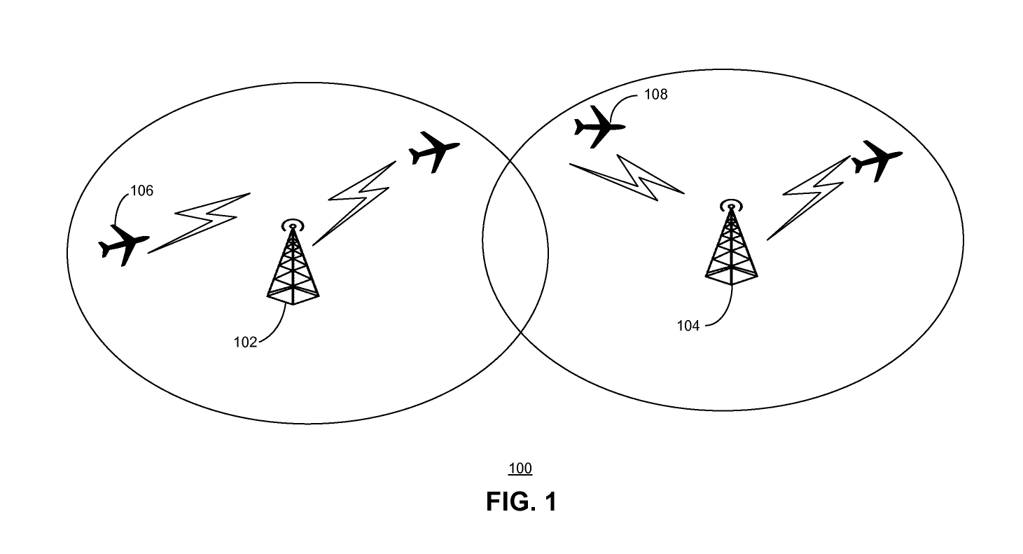

In recent years, the communication between aircraft in the air and ground control has migrated from simple voice communication between crew members and ground control to sophisticated reporting of flight status data. Moreover, long-range (greater than 200 miles) base stations are built along the path of the flight to ensure continuous broadband communication links between the aircraft and the ground. FIG. 1 presents a diagram illustrating an exemplary aviation cellular communication system. In FIG. 1, aviation cellular communication system 100 includes a number of base stations, such as base stations 102 and 104; and a number of aircraft communicating with the base stations. Similar to the public cellular communication system, each aircraft communicates with a particular base station when it flies into the range of that base station. For example, in FIG. 1, aircraft 106 is communicating with base station 102, and aircraft 108 is communicating with base station 104. As one can see, the number of aircraft within a particular cell fluctuates as aircraft flying in and out of a cell, similar to the public cellular system where users move in and out of a cell. In other words, in each cell, traffic loads fluctuate.

Conventional aviation cellular communication systems typically provide simple services, such as voice communications and ACARS (Aircraft Communications Addressing and Reporting System) messaging, and often do not require large bandwidths. However, as the flight data complexity increases and the demand for providing in-flight broadband service emerges, it is desirable to increase the data rate in current aviation cellular communication systems.

As discussed previously, LTE has provided users with a much higher data rate than previously developed second generation (2G) and third generation (3G) technologies. For example, LTE Advanced promised up to 1 Gbps downlink speed by implementing carrier aggregation (also known as channel aggregation). Therefore, one natural solution for increasing the data rate in aviation cellular communication systems is to implement LTE in those systems. However, because the spectrum allocation in aviation cellular communication systems is very different from that of the public cellular communication systems, for which the LTE developed, LTE technologies usually cannot be directly applied to the aviation cellular communication systems. More specifically, the operation frequency bands and the channel bandwidth are very different in these two types of systems.

In the United States, LTE networks use various frequency bands centered at 700, 750, 800, 850, 1900, 1700/2100, and 2500 MHz, whereas aviation cellular communication systems use a frequency band between 200 and 400 MHz. Moreover, because aviation cellular communication systems are traditionally used for voice communications, they are often assigned narrow channels (or small pieces of spectrum) within the 200-400 MHz frequency band, such as channels with a bandwidth of 500 KHz or 1.2 MHz. For example, a particular aviation cellular communication system may support up to ten 500 KHz channels and five 1.2 MHz channels. The positions of these channels may change periodically. On the other hand, the LTE standard supports channels at fixed positions with a minimum channel bandwidth of 1.4 MHz. More specifically, although allowing increased spectrum flexibility compared with previous technologies, LTE only supports channel bandwidths of 1.4, 3, 5, 10, 15, and 20 MHz. The narrower channel bandwidth of the aviation cellular communication systems makes it impossible to directly implement LTE.

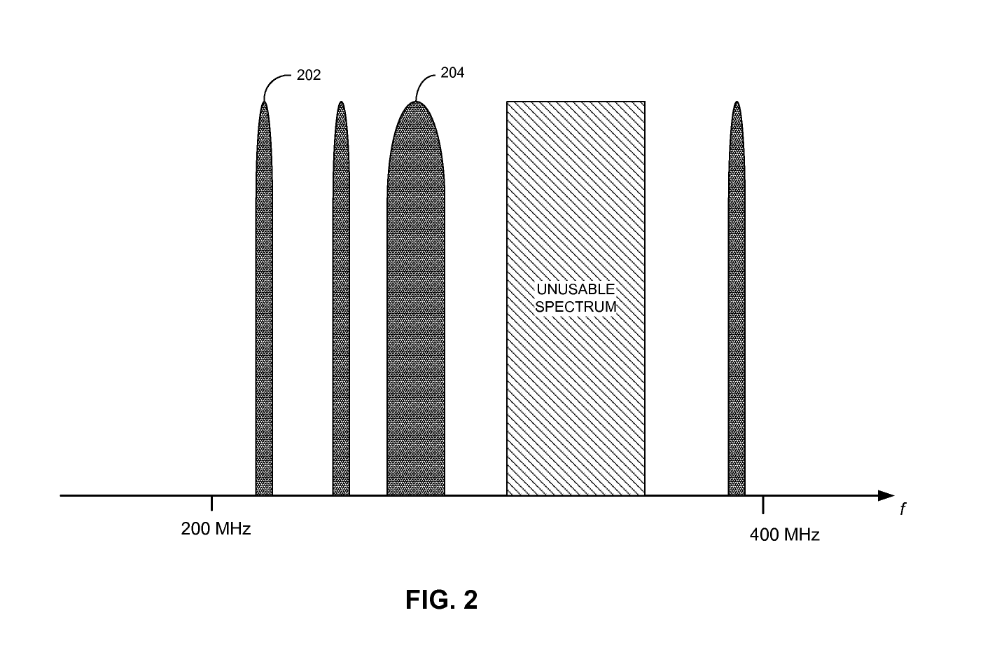

FIG. 2 presents a diagram illustrating the distribution of available spectrum within an aviation cellular communication system. In FIG. 2, within the frequency band that ranges from 200 MHz to 400 MHz, there are scattered pieces of spectrum, such as spectrum pieces 202 and 204, which are available for provisioning to aircraft. In addition, there may be a region of unusable spectrum within the frequency band. The spectrum pieces available for resource provisioning can be quite narrow. For example, spectrum piece 202 has a bandwidth of merely 500 KHz, and spectrum piece 204 has a bandwidth of around 1.2 MHz. Clearly, the spectrum pieces shown in FIG. 2 do not comply with the LTE standard, which defines possible channel bandwidths as 1.4, 3, 5, 10, 15, and 20 MHz.

In order to implement LTE, embodiments of the present invention define logical channels within the 200-400 MHz frequency band to meet LTE channel requirements. For example, a logical channel may have a bandwidth of 20 MHz, which is the largest possible bandwidth defined in the LTE standard. Each logical channel will include one or more scattered spectrum pieces.

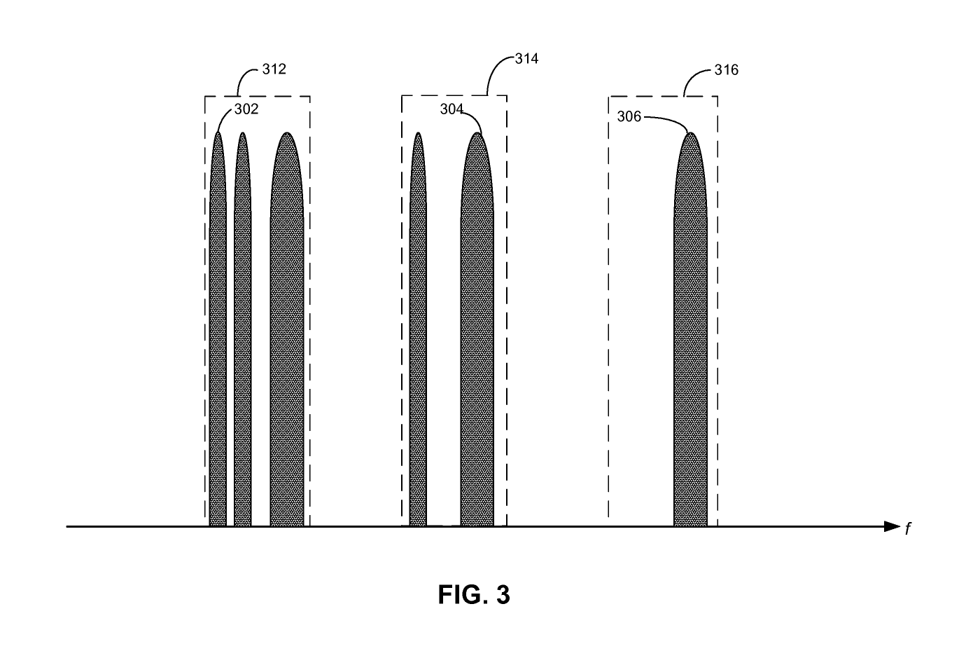

FIG. 3 presents a diagram illustrating an exemplary scenario where logical channels are defined, in accordance with an embodiment of the present invention. FIG. 3 illustrates a number of available spectrum pieces, such as spectrum pieces 302, 304, and 306. Depending on the actual system, the bandwidths of the spectrum pieces may be of certain fixed values or arbitrary values. In some embodiments, the bandwidths of the spectrum pieces can be 500 kHz, 1.2 MHz, or any other arbitrary value. For example, spectrum piece 302 has a bandwidth of 500 kHz, and the bandwidth of spectrum pieces 304 and 306 is about 1.2 MHz.

FIG. 3 also illustrates a number of logical channels that are defined to encompass the spectrum pieces. More specifically, a logical channel 312 is defined to encompass spectrum piece 302 and two other adjacent spectrum pieces; logical channel 314 encompasses spectrum piece 304 and an adjacent spectrum piece; and logical channel 316 encompasses a single spectrum piece 306. The logical channels are defined to be in compliance with current LTE standards. For example, the bandwidths of the defined logical channels can be 1.4 MHz, 3 MHz, 5 MHz, 10 MHz, or 20 MHz. In some embodiments, the bandwidth of the defined logical channels is 20 MHz.

In further embodiments, the logical channels are defined in such a way that a single logical channel can encompass as many available spectrum pieces as possible. For example, in FIG. 3, the system defines a logical channel 312 in order to encompass spectrum piece 302 and two other adjacent spectrum pieces. Similarly, logical channel 314 is defined at a spectrum location to encompass spectrum piece 304 and an adjacent spectrum piece; and logical channel 316 is defined to encompass spectrum piece 306. Note that the system may run an optimization algorithm to determine the best strategy to define the logical channels. In one embodiment, the optimization goal can be to ensure that the ratio between the available spectrum in the defined channels and the unavailable spectrum in the defined channels is maximized.

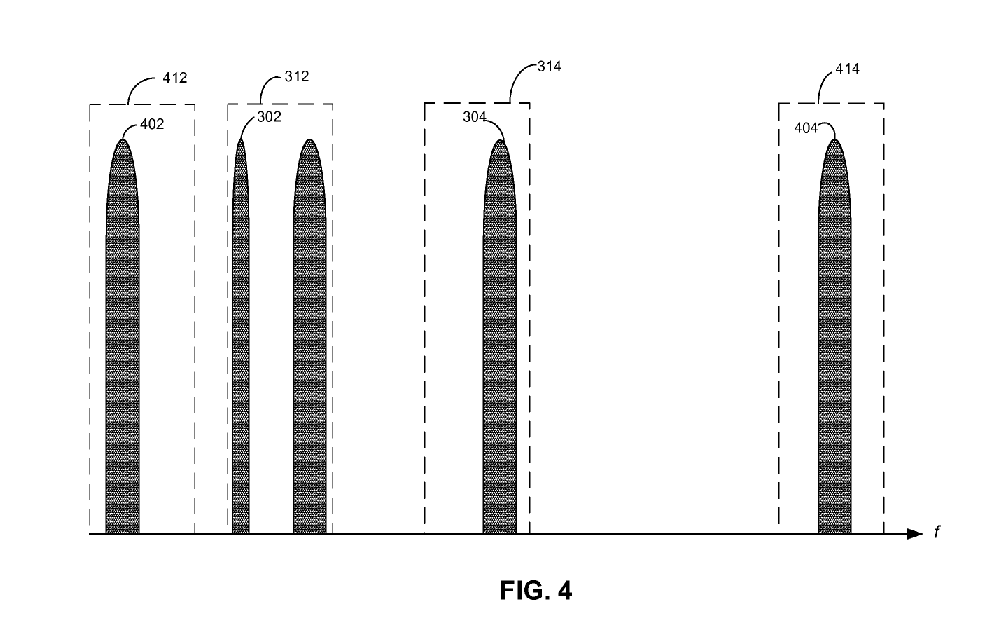

In certain communication systems the number and location of the available spectrum pieces can change periodically. Accordingly, the system redefines a number of logical channels to encompass current available spectrum pieces. FIG. 4 presents a diagram illustrating an update to the logical channels in response to an update to the available spectrum, in accordance with an embodiment of the present invention. Compared with FIG. 3, one can see that in FIG. 4, one of the spectrum pieces adjacent to spectrum piece 302, the one adjacent to spectrum piece 304, and spectrum piece 306 are no longer available.

On the other hand, two new spectrum pieces, spectrum pieces 402 and 404, become available for provisioning. In response to this spectrum change, the system updates its assignment of logical channels. In FIG. 4, logical channels 312 and 314 remain unchanged, even though the spectrum pieces within these two logical channels have been updated. Logical channel 316 from FIG. 3 no longer exists because there is no available spectrum at the corresponding spectrum location. In addition, the system defines two new logical channels, channels 412 and 414, to encompass the newly available spectrum pieces 402 and 404, respectively.

In the examples shown in FIGS. 3 and 4, when defining the logical channels, the system did not consider the synchronization requirements. In practice, a user equipment (UE) wishing to access the LTE system follows a cell search procedure which includes a series of synchronization stages by which the UE determines time and frequency parameters that are necessary to demodulate downlink signals, to transmit with correct timing and to acquire some critical system parameters. During synchronization stages, the UE uses two special signals broadcast on each cell: Primary Synchronization Sequence (PSS) and Secondary Synchronization Sequence (SSS), which occupy the central 6 RBs, irrespective of the system channel bandwidth, which allows the UE to synchronize to the network without a priori knowledge of the allocated bandwidth. Note that 6 RBs requires a minimum bandwidth of 6×180 kHz=1.08 MHz. Therefore, to implement LTE in a system of scattered spectrum pieces by defining logical channels, one needs to ensure that there are at least 6 RBs available at the center of each logical channel. In some embodiments, when defining logical channels, the system locates a spectrum piece that is at least 1.08 MHz (6 RBs) wide, uses the location of this spectrum piece as an anchor point, and defines a logical channel that centers at the anchor point.

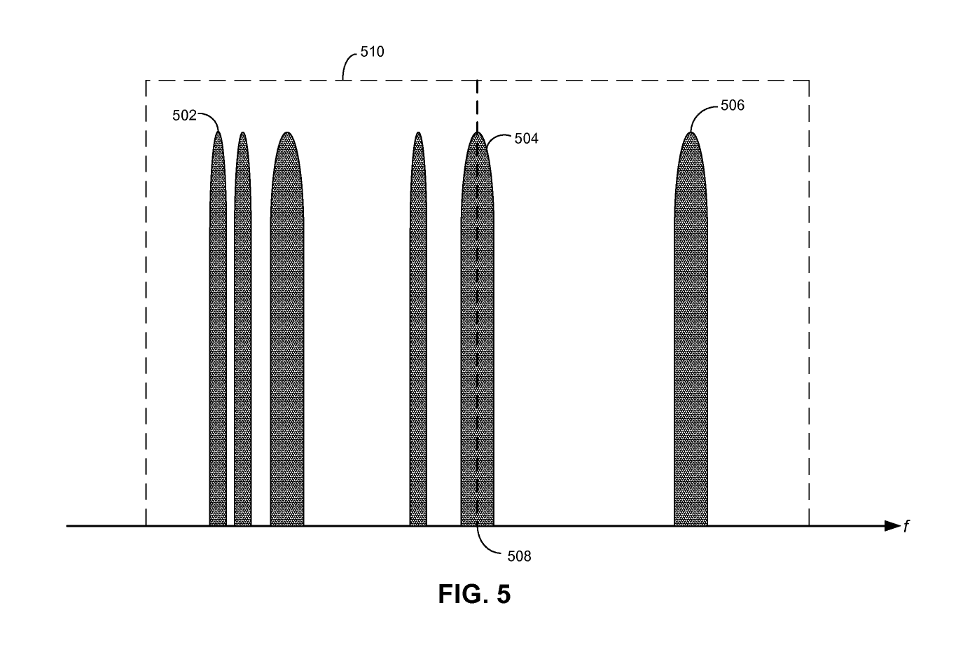

FIG. 5 presents a diagram illustrating defining logical channels around an anchor point, in accordance with an embodiment of the present invention. In FIG. 5, the spectral profile is similar to the one shown in FIG. 3, which includes a number of scattered spectrum pieces, some of which are narrower and some of which are wider. For example, spectrum piece 502 has a bandwidth of 500 kHz, and spectrum pieces 504 and 506 each have a bandwidth of 1.2 MHz. The 500 kHz spectrum piece only contains 2 RBs, and hence is not sufficient for synchronization. On the other hand, the 1.2 MHz spectrum pieces include 6 RBs, and can be used for LTE synchronization. In some embodiments, the system identifies a sufficiently wide spectrum piece, such as spectrum piece 504, and marks the center location of that spectrum piece as an anchor point, such as anchor point 508. The system then defines a logical channel with the center of the logical channel at the anchor point. In the example shown in FIG. 5, a logical channel 510 with a bandwidth of 20 MHz is defined to encompass the spectrum pieces, and the center of logical channel 510 is anchor point 508. Consequently, the central 6 RBs of logical channel 510 will be within spectrum piece 504, and synchronization signals (including both PSS and SSS) will be broadcast over these 6 RBs. In other words, spectrum piece 504 is mostly used for synchronization. Other spectrum pieces, such as spectrum pieces 502 and 506, provide RBs that can be dynamically assigned to UEs. Note that each 500 kHz spectrum piece provides 2 RBs, and each 1.2 MHz spectrum piece provides 6 RBs. In the example shown in FIG. 5, it also possible to choose other spectrum pieces, such as spectrum piece 506, as an anchor point when defining logical channels, as long as the chosen spectrum piece is at least 1.08 MHz wide. Compared with a conventional 20 MHz channel in LTE, which can provide 100 continuous RBs, the logical channels defined for the system with scattered spectrum pieces often provides fewer RBs. More specifically, different logical channels may encompass spectrum pieces of different numbers and sizes. Note that, if all spectrum pieces available in the system are at least 1.08 MHz wide, the system can select any spectrum piece as an anchor point to define a logical channel. In this case, the logical channels can be defined to optimize the ratio of the usable spectrum among all channels.

The system can then run LTE scheduling to provision the aircraft requesting resources. Note that, unlike conventional LTE systems, the available resources in each channel are not continuously aligned RBs but scattered spectrum pieces, with each piece providing 2 or 6 RBs. The scheduler, on the other hand, is aware of the location and size of the spectrum pieces in each channel, and provisions accordingly. For example, if an aircraft is requesting 2 RBs, the scheduler may assign a 500 kHz spectrum piece to the aircraft. On the other hand, if an aircraft is requesting 8 RBs, the scheduler may assign a 500 kHz spectrum piece and a 1.2 MHz spectrum piece to the aircraft. Alternatively, the scheduler may treat all RBs as individual RBs regardless of which spectrum pieces they belong to. In some embodiments, the RBs within each logical channel are numbered in a way that is similar to LTE with the index of an RB reflecting its spectral location, except that the available RBs are not numbered continuously because they belong to scattered spectrum pieces. For example, a logical channel may include RBs No. 2, No. 3, No. 15, No. 16, No. 20, and so on. The discontinuity of the indices of the RBs indicates frequency gaps among the RBs. In alternative embodiments, the RBs are indexed continuously, starting from the subcarrier of the lowest frequency, similar to the RB indexing in conventional LTE systems. However, in the instant system the continuously indexed RBs are not continuous in frequency. Instead, frequency gaps may exist for RBs that are consecutively indexed. For example, RB No. 2 may belong to a spectrum piece 502, and RB No. 3 may belong to the spectrum piece adjacent to spectrum piece 502. As one can see, because the spectrum pieces are scattered, there is a frequency gap between spectrum piece 502 and its adjacent spectrum piece. As a result, there will be a frequency gap between RB No. 2 and RB No. 3. When scheduling, the scheduler may allocate continuously indexed RBs starting with the lowest indexed RB to aircraft requesting bandwidth.

In certain situations, all available RBs in a defined logical channel may not meet the user demand for data rate. To meet such user demands, channel aggregation may be needed. Current LTE technology enables different types of channel aggregation (also called carrier aggregation), including intraband contiguous carrier aggregation, intraband non-contiguous carrier aggregation, and interband non-contiguous carrier aggregation. However, these aggregation schemes are static solutions designed for systems with fixed channel locations, whereas in the commercial cellular system, such as the aviation cellular system, the location and bandwidth of the channels may change over time. In addition, demands for resources may also be time varying, meaning that channel aggregation may not always be needed. Considering that performing channel aggregation adds system complexity, it is desirable to have a dynamic solution that can work with time-varying resources and only invoke channel aggregation when needed.

In some embodiments of the present invention, the aggregation of the logical channels may happen on demand. In other words, the system may determine, based on user (aircraft requesting bandwidth) need, whether to aggregate multiple channels. For example, when the number of active users is low, the system may determine that a single logical channel that includes sufficient spectrum pieces can provide enough resource blocks (RBs) to meet all user need. On the other hand, when the number of active users increases, the system may determine that the single logical channel cannot provide enough RBs to meet all user need, and that two logical channels are needed. Consequently, the system can aggregate two logical channels. If the number of users continues to increase, the system may need to aggregate more logical channels in order to provide enough RBs to meet the need of all users. In other words, embodiments of the present invention provide a dynamic resource-provisioning scheme that performs on-demand channel aggregation.

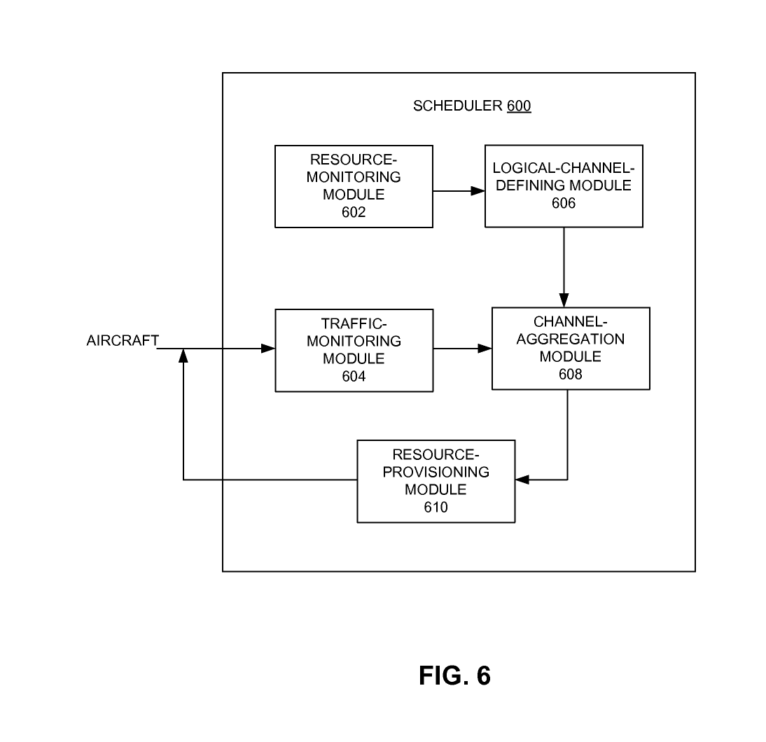

FIG. 6 presents a diagram illustrating the exemplary architecture of a scheduler, in accordance with an embodiment of the present invention. In FIG. 6, a scheduler 600 includes a resource-monitoring module 602, a traffic-monitoring module 604, a logical-channel-defining module 606, a channel-aggregation module 608, and a resource-provisioning module 610.

Resource-monitoring module 602 is responsible for monitoring the status of available resources. In a communication system whose usable spectrum includes periodically updated and scattered small spectrum pieces, resource-monitoring module 602 identifies currently available spectrum pieces and determines their bandwidths and spectrum locations.

Logical-channel-defining module 606 is responsible for defining logical channels. More specifically, logical-channel-defining module 606 receives input from resource-monitoring module 602, which indicates the bandwidths and spectrum locations of all currently available spectrum pieces, and defines a number of logical channels that collectively encompass all the currently available spectrum pieces. In some embodiments, logical-channel-defining module 606 defines logical channels that meet the channel bandwidth requirement of the LTE standard. In other words, the defined logical channels may have a bandwidth of 1.4 MHz, 3 MHz, 5 MHz, 10 MHz, or 20 MHz. Moreover, to ensure proper LTE synchronization, logical-channel-defining module 606 first identifies a spectrum piece that is at least as wide as 1.08 MHz, and uses the identified spectrum piece as an anchor point to define logical channels in such a way that the center of the logical channel is the center of the identified spectrum piece.

In some embodiments, logical-channel-defining module 606 may define logical channels in such a way that all spectrum pieces are encompassed by a minimum number of channels. In other words, the resulting system has a minimum number of channels. In further embodiments, the channel bandwidth may be predetermined or optimized based on the currently available spectrum pieces. In some embodiments, logical-channel-defining module 606 may define logical channels at fixed spectrum locations having a predetermined bandwidth. Note that there is tradeoff between spectral efficiency and computation complexity. Note that, in cases where some scattered spectrum pieces are narrower than 1.08 MHz, to implement LTE, logical-channel-defining module 606 first identifies one or more spectrum pieces that are at least 1.08 MHz, and then uses the identified spectrum pieces as anchor points to define logical channels. Logical-channel-defining module 606 can define logical channels in such a way that the identified spectrum pieces are at the center of the defined logical channels.

Traffic-monitoring module 604 is responsible for monitoring the current traffic need. In some embodiments, traffic-monitoring module 604 may be responsible for receiving requests from aircraft for resources (bandwidth). The traffic-monitoring output, which may indicate the number of aircraft requesting bandwidth, is sent to channel-aggregation module 608.

Channel-aggregation module 608 is responsible for aggregating multiple logical channels based on the defined channels and the traffic-monitoring output. In some embodiments, channel-aggregation module 608 may determine, based on the defined logical channels and the traffic monitoring output, whether a single defined channel is sufficient to meet current traffic need. If so, channel-aggregation module 608 may identify that single channel, and instruct resource-provisioning module 610 to allocate available RBs within the identified single channel to users. On the other hand, channel-aggregation module 608 may determine that none of the single channels can by itself meet the current traffic need, and channel aggregation is needed. In this case, channel-aggregation module 608 may identify a number of channels that, when aggregated, can provide sufficient resources to meet the current traffic need.

Note that, compared to a standard LTE system where channels are identical (i.e., they all include continuous frequency resources that extend throughout the entire channel bandwidth), in the current communication system, the dynamically defined logical channels are not identical, as different logical channels may include different available spectrum pieces. For example, in FIG. 3, logical channel 312 has 4×500 kHz=2 MHz usable spectrum, and logical channel 314 has 500 kHz+1.2 MHz=1.25 MHz. In some embodiments, channel-aggregation module 608 computes a channel-aggregation solution that requires reduced aggregation efforts. In further embodiments, the optimized solution aggregates as few channels as possible. For example, channel-aggregation module 608 can sort the logical channels based on the available spectrum within each channel, starting with the channel having the largest available spectrum, and adding one channel at a time until the aggregated channel can provide sufficient bandwidth to meet the current traffic need. In the example shown in FIG. 3, logical channels 312 and 314 may be the first to be aggregated. In some embodiments, channel-aggregation module 608 may simply start from the leftmost logical channel (the channel with the lowest carrier frequency) and aggregate sequentially toward the right until the aggregated channel can provide sufficient bandwidth to meet the current traffic need. In FIG. 4, logical channels 412 and 312 may be the first to be aggregated. Similarly, it is also possible to start from the rightmost and move toward the left.

Resource-provisioning module 610 is responsible for allocating resources, such as RBs, to aircraft. In some embodiments, resource-provisioning module 610 allocates RBs from an aggregated channel (meaning that they may be located in different logical channels) to an aircraft requesting bandwidth. The RBs may belong to the same or different spectrum pieces.

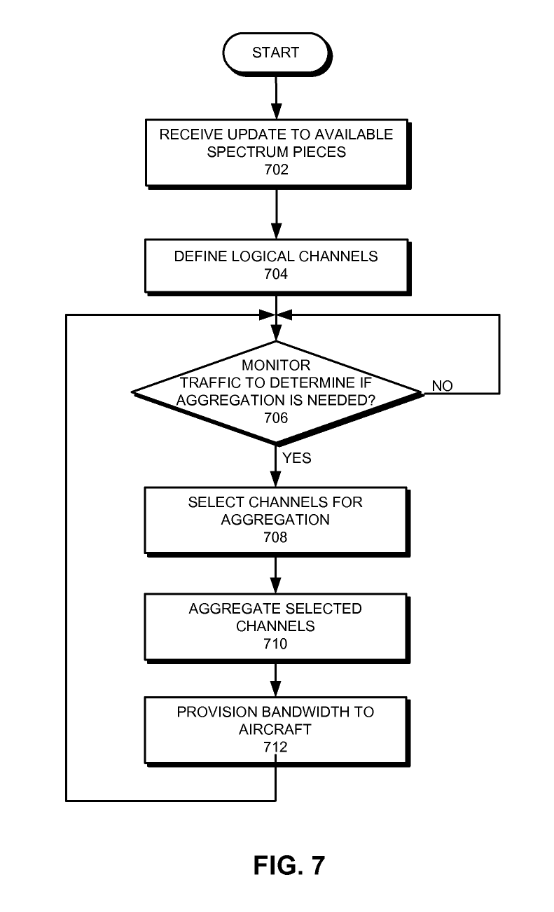

FIG. 7 presents a flowchart illustrating an exemplary bandwidth provisioning process, in accordance with an embodiment of the present invention. During operation, the system receives an update to the available spectrum pieces (operation 702). Note that, in many wireless communication systems, spectrum pieces that are available for provisioning may change periodically. For example, the Federal Communications Commission (FCC) has allocated certain frequency bands for aviation purposes. For example, civil aviation uses a band between 108 and 137 MHz for radio communication, and military aircraft uses a UHF band that is between 225.0 and 399.95 MHz for air-to-air and air-to-ground communication. Within each frequency band, the channels (spectrum pieces) that are available for usage may be updated periodically. For example, the regulatory authorities may re-assign a spectrum, or some spectrum pieces that were previously in use may now be released and become available.

Based on the available spectrum pieces, the system defines one or more logical channels that encompass all of the available spectrum pieces (operation 704). For systems with available resources being updated periodically, the defined logical channels are updated accordingly. In some embodiments, while defining the logical channels, the system identifies anchor points, i.e., spectrum pieces that are at least 1.08 MHz wide. The logical channels are defined in such a way that they are centered at these anchor points. In some embodiments, the logical channels are defined in such a way that the channel bandwidths are in compliance with the LTE standard.

The system then determines, based on current traffic needs, whether channel aggregation is needed (operation 706). In some embodiments, the system may determine whether the total spectrum pieces within any single logical channel can meet the traffic need. If channel aggregation is needed, the system selects multiple channels to be aggregated (operation 708). The system may select aggregated channels based on certain criteria. In some embodiments, the system selects a minimum number of channels that can meet the current traffic needs. In some embodiments, the system may sequentially, following the spectrum order, select channels until the aggregated channel is large enough to meet the traffic need. The system then aggregates the selected channels into an aggregated channel (operation 710). In some embodiments, the system aggregates the channels in a way that is similar to LTE carrier aggregation. Once the aggregated channel is formed dynamically, the system can provision bandwidth to users or services (operation 712). For example, the system may allocate RBs, which are located within different logical channels but are within the aggregated channel, to a user or a service. In some embodiments, the resource-assignment information is sent to UEs via control messages similar to the ones used in LTE. Note that, in LTE carrier aggregation, the component carriers are numbered to allow the scheduling to specify which component carrier a grant relates to. In LTE, the RBs within each channel are continuous subcarriers. On the other hand, in embodiments of the present invention, the bandwidth resources (RBs) in each logical channel are not necessarily continuous subcarriers; therefore, an appropriate naming scheme is needed to identify each available RB. In some embodiments, the RBs within each logical channel are numbered in a way that is similar to LTE with the index of an RB reflecting its spectral location, except that the available RBs are not numbered continuously because they belong to scattered spectrum pieces. Alternatively, the RBs are indexed continuously, but consecutively indexed RBs may be separated by spectrum gaps. The system continues to monitor the traffic to determine whether the aggregation is still needed by returning to operation 706. In some embodiments, if the system determines that the current traffic need does not require channel aggregation, the system may disaggregate the previously aggregated channels and provision bandwidth to users using resources contained in a single logical channel. Note that the scheduling overhead can be reduced when channel aggregation is not used. Therefore, by aggregating channels on-demand, embodiments of the present invention can reduce the overall scheduling complexity.

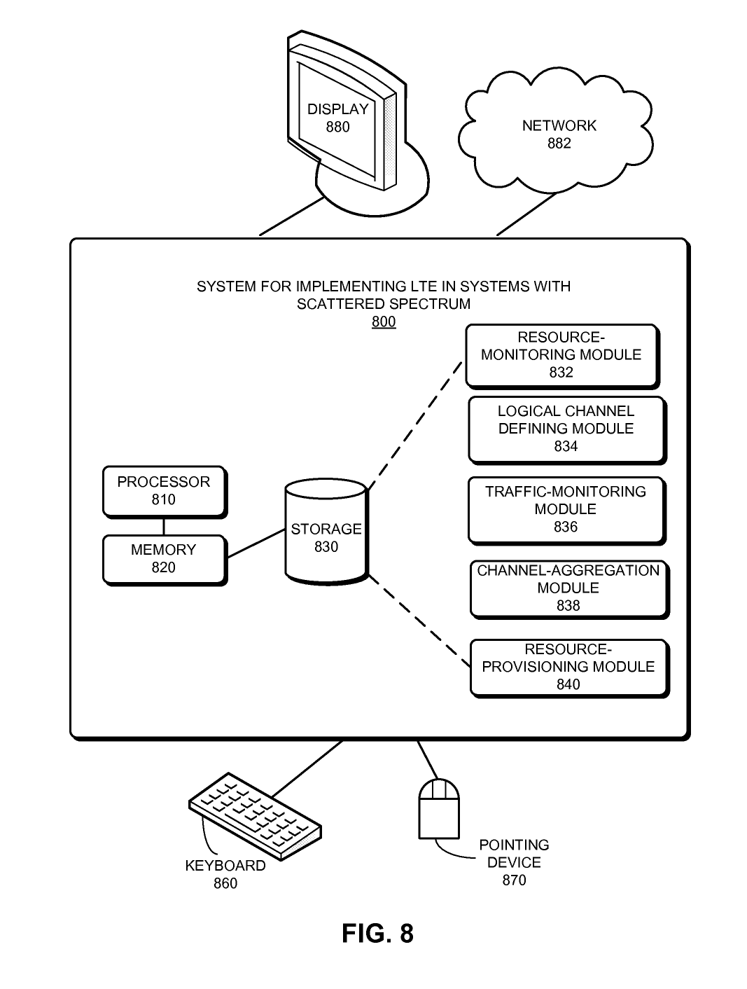

FIG. 8 illustrates an exemplary system for implementing LTE in systems with scattered spectrum, in accordance with an embodiment of the present invention. A system 800 comprises a processor 810, a memory 820, and a storage 830. Storage 830 typically stores instructions that can be loaded into memory 820 and executed by processor 810 to perform the methods mentioned above. In one embodiment, the instructions in storage 830 can implement a resource-monitoring module 832, a logical-channel defining module 834, a traffic-monitoring module 836, a channel-aggregation module 838, and a resource-provisioning module 840, all of which can be in communication with each other through various means.

In some embodiments, modules 832, 834, 836, 838, and 840 can be partially or entirely implemented in hardware and can be part of processor 810. Further, in some embodiments, the system may not include a separate processor and memory. Instead, in addition to performing their specific tasks, modules 832, 834, 836, 838, and 840, either separately or in concert, may be part of general- or special-purpose computation engines.

Storage 830 stores programs to be executed by processor 810. Specifically, storage 830 stores a program that implements a system (application) for implementing LTE in systems with scattered spectrum. During operation, the application program can be loaded from storage 830 into memory 820 and executed by processor 810. As a result, system 800 can perform the functions described above. System 800 can be coupled to an optional display 880 (which can be a touchscreen display), a keyboard 860, and a pointing device 870, and can also be coupled via one or more network interfaces to network 882.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method for implementing Long-Term Evolution (LTE) scheduling in a wireless communication system with scattered spectrum, comprising:
determining, by a scheduler, bandwidth resources that are available in the wireless communication system, wherein the available bandwidth resources comprise a plurality of scattered spectrum pieces;
identifying a spectrum piece with a bandwidth that is equal to or larger than a predetermined threshold;
defining a logical channel that is centered at the identified spectrum piece; and
performing LTE scheduling based on the defined logical channel, wherein the LTE scheduling involves provisioning a user or a service using spectrum pieces encompassed in the defined logical channel.

2. The method of claim 1, further comprising:
monitoring traffic need;
in response to determining that spectrum pieces encompassed by the logical channel do not meet the traffic need, aggregating multiple logical channels to obtain an aggregated channel; and
provisioning the user or the service using spectrum pieces encompassed in the aggregated channel.

3. The method of claim 2, wherein aggregating the multiple logical channels involves performing LTE carrier aggregation.

4. The method of claim 2, further comprising:
in response to determining that spectrum pieces encompassed by a single logical channel meet traffic need, disaggregating previously aggregated multiple logical channels.

5. The method of claim 1, wherein the defined logical channel has a bandwidth that is in compliance with an LTE standard.

6. The method of claim 1, wherein the wireless communication system includes an aviation cellular communication system, and wherein the scattered spectrum pieces are located within a frequency band between 200 MHz and 400 MHz.

7. The method of claim 1, wherein the scattered spectrum pieces include a number of 500 kHz wide spectrum pieces and a number of 1.2 MHz wide spectrum pieces, and wherein the identified spectrum piece is 1.2 MHz wide.

8. A non-transitory computer-readable storage medium storing instructions that when executed by a computing device cause the computing device to perform a method for implementing Long-Term Evolution (LTE) scheduling in a wireless communication system with scattered spectrum, the method comprising:
determining, by a scheduler, bandwidth resources that are available in the wireless communication system, wherein the available bandwidth resources comprise a plurality of scattered spectrum pieces;
identifying a spectrum piece with a bandwidth that is equal to or larger than a predetermined threshold;
defining a logical channel that is centered at the identified spectrum piece; and
performing LTE scheduling based on the defined logical channel, wherein the LTE scheduling involves provisioning a user or a service using spectrum pieces encompassed in the defined logical channel.

9. The computer-readable storage medium of claim 8, wherein the method further comprises:
monitoring traffic need;
in response to determining that spectrum pieces encompassed by the logical channel do not meet the traffic need, aggregating multiple logical channels to obtain an aggregated channel; and
provisioning the user or the service using spectrum pieces encompassed in the aggregated channel.

10. The computer-readable storage medium of claim 9, wherein aggregating the multiple logical channels involves performing LTE carrier aggregation.

11. The computer-readable storage medium of claim 9, wherein the method further comprises:
in response to determining that spectrum pieces encompassed by a single logical channel meet traffic need, disaggregating previously aggregated multiple logical channels.

12. The computer-readable storage medium of claim 8, wherein the defined logical channel has a bandwidth that is in compliance with an LTE standard.

13. The computer-readable storage medium of claim 8, wherein the wireless communication system includes an aviation cellular communication system, and wherein the scattered spectrum pieces are located within a frequency band between 200 MHz and 400 MHz.

14. The computer-readable storage medium of claim 8, wherein the scattered spectrum pieces include a number of 500 kHz wide spectrum pieces and a number of 1.2 MHz wide spectrum pieces, and wherein the identified spectrum piece is 1.2 MHz wide.

15. A scheduler that implements Long-Term Evolution (LTE) scheduling in a wireless communication system with scattered spectrum, comprising:
a resource-monitoring module configured to determine bandwidth resources that are available in the wireless communication system, wherein the available bandwidth resources comprise a plurality of scattered spectrum pieces;
an identifying module configured to identify a spectrum piece with a bandwidth that is equal to or larger than a predetermined threshold;
a channel-defining module configured to define a logical channel that is centered at the identified spectrum piece; and
a provisioning module configured to provision a user or a service using spectrum pieces encompassed in the defined logical channel.

16. The scheduler of claim 15, further comprising:
a traffic monitor configured to monitor traffic need; and
a channel aggregator configured to aggregate multiple logical channels to obtain an aggregated channel in response to determining that spectrum pieces encompassed by the logical channel do not meet the traffic need,
wherein the provisioning module is configured to provision the user or the service using spectrum pieces encompassed in the aggregated channel.

17. The scheduler of claim 16, wherein the channel aggregator is configured to perform LTE carrier aggregation.

18. The scheduler of claim 16, wherein the channel aggregator is further configured to, in response to determining that spectrum pieces encompassed by a single logical channel meet traffic need, disaggregate previously aggregated multiple logical channels.

19. The scheduler of claim 18, wherein the defined logical channel has a bandwidth that is in compliance with an LTE standard.

20. The scheduler of claim 15, wherein the wireless communication system includes an aviation cellular communication system, and wherein the scattered spectrum pieces are located within a frequency band between 200 MHz and 400 MHz.

21. The scheduler of claim 15, wherein the scattered spectrum pieces include a number of 500 kHz wide spectrum pieces and a number of 1.2 MHz wide spectrum pieces, and wherein the identified spectrum piece is 1.2 MHz wide.
